(19) United States
(12) Patent Application Publication
(10) Pub. No.: US 2016/0366279 A1
(43) Pub. Date: Dec. 15, 2016

(54) TELEPHONE SURVEYING FOR MISDIRECTED CALLS

(71) Applicant: Reconnect Research, Los Angeles, CA (US)

(72) Inventor: Scott Richards, Los Angeles, CA (US)

(21) Appl. No.: 15/174,569

(22) Filed: Jun. 6, 2016

Related U.S. Application Data
(60) Provisional application No. 62/173,231, filed on Jun. 9, 2015.
(60) Provisional application No. 62/174,231, filed on Jun. 11, 2015.

(51) Int. Cl. H04M 3/527; H04M 3/42; G06Q 30/02; H04M 3/54

(52) U.S. Cl. CPC H04M 3/527; H04M 3/543; H04M 3/42059; G06Q 30/0217; G06Q 30/0203; H04M 2203/1041; H04M 2242/30

(57) ABSTRACT

A system and method for conducting telephone surveys includes a management controller that receives a misdirected call by a caller with an incoming number, extracts caller data for the caller, based on the incoming number, and determines whether the caller wishes to participate in a telephone survey for a reward. The management controller plays at least one voice message to ask the caller for caller data, in response to the caller wishing to participate, and receives caller data from the caller, in response to the voice message. The management controller selects a survey from a pool of available surveys for the caller, based on the caller data, and connects the caller to the survey.

### CROSS-REFERENCE TO RELATED APPLICATIONS

This application is related, and claims priority, to U.S. Provisional Patent Application No. 62/173,231 filed Jun. 9, 2015, entitled “SYSTEM AND METHOD FOR IDENTIFYING SURVEY PARTICIPANTS,” and U.S. Provisional Patent Application No. 62/174,231 filed Jun. 11, 2015, entitled “SYSTEM AND METHOD FOR IDENTIFYING SURVEY PARTICIPANTS.” The disclosures of these prior applications are considered part of, and are incorporated by reference in this disclosure.

### BACKGROUND

Field

This application relates to telephone surveys, and more particularly to a system and method for using misdirected calls to conduct telephone surveys.

Background

Market survey data collection systems are known in the art. Telephone-based survey systems are called upon to handle a high caller volume at a relatively low cost in a manner that insures wide audience acceptability and that provides highly reliable data.

The use of telephone solicitation and survey taking is also known in the industry. However, there are major limitations that inhibit the ability to conduct a survey in an easy, inexpensive, and timely manner. Computer-based systems have been developed to reduce the high costs in soliciting answers to survey questions. For example, touch-tone phone systems have been used for normal telephone conversations and as datasets for collecting responses to survey questions. Specifically, recent systems act as verbally interactive telephone interrogation systems using a conventional two-way telephone network.

Interactive voice response (IVR) systems are also known. IVR refers to a computerized system that allows a user, typically a telephone caller, to select an option from a voice menu or otherwise interface with a computer system. Generally, an IVR system plays pre-recorded voice prompts to which the user responds by either pressing a number on a telephone keypad or speaking to the system. However, the costs of manually calling large numbers of individuals, that may not answer the call, to conduct a telephone survey remain significant.

Identifying a suitable and representative sample population is one particular challenge for telephone surveys. In particular, individuals with unlisted telephone numbers may not appear in a public database and therefore may not be available to telephone solicitation. In addition, as more users shift to wireless or cellular communication as their primary telephone, it becomes more difficult to identify them for telephone surveys simply because their names and telephone numbers are not as well represented in public databases.

### SUMMARY

The following presents a simplified summary of one or more embodiments in order to provide a basic understanding of the present technology. This summary is not an extensive overview of all contemplated embodiments of the present technology, and is intended to neither identify key or critical elements of all examples nor delineate the scope of any or all aspects of the present technology. Its sole purpose is to present some concepts of one or more examples in a simplified form as a prelude to the more detailed description that is presented later.

In some implementations, a system and method for conducting telephone surveys includes a management controller that receives a misdirected call by a caller with an incoming number, extracts caller data for the caller, based on the incoming number, and determines whether the caller wishes to participate in a telephone survey for a reward. The management controller plays at least one voice message to ask the caller for caller data, in response to the caller wishing to participate, and receives caller data from the caller, in response to the voice message. The management controller selects a survey from a pool of available surveys for the caller, based on the caller data, and connects the caller to the survey.

In some implementations, a method for conducting telephone surveys includes receiving, from a surveyor, survey setup data, receiving a misdirected call by a caller with an incoming number, and extracting caller data for the caller, based on the incoming number. The method includes determining whether the caller wishes to participate in a telephone survey, with the potential for a reward, selecting a survey from a pool of available surveys for the caller, based on the caller data, and connecting the caller to the survey. The method further includes providing reward information, when applicable, to the caller for collecting the reward, in response to the caller completing the survey, wherein the reward corresponds to the survey.

### BRIEF DESCRIPTION OF THE DRAWINGS

These and other sample aspects of the present technology will be described in the detailed description and the appended claims that follow, and in the accompanying drawings, wherein:

FIG. 1 illustrates a block diagram of an example system for conducting telephone surveys;

FIG. 2 illustrates a flow chart of an example method for conducting telephone surveys;

FIG. 3 illustrates a first example method for conducting telephone surveys;

FIG. 4 illustrates a second example method for conducting telephone surveys;

FIG. 5 illustrates a block diagram of an example computer system for conducting telephone surveys; and

FIG. 6 illustrates a block diagram of an example system for conducting telephone surveys.

### DETAILED DESCRIPTION

The subject disclosure provides techniques for using misdirected calls to conduct telephone surveys. Various aspects of the present technology are described with reference to the drawings. In the following description, for purposes of explanation, numerous specific details are set forth in order to provide a thorough understanding of one or more aspects. It is evident, however, that the present technology can be practiced without these specific details. In other instances, well-known structures and devices are shown in block diagram form in order to facilitate describing these aspects.

The subject disclosure provides systems and methods for connecting people on the phone, that have not, in most cases, connected to their intended destination. Instead, the people are connected to research surveys and political polls and are part of the survey sample. These are misdirected calls and for the purposes of this specification, include a category of telephone calls (i.e., misdials) where a caller accidentally dials an unused telephone number. Instead of immediately disconnecting the caller, playing a preset voice message, or redirecting the caller to another number, the misdialed caller can be directed to participate in a telephone survey. These types of misdirected calls might also be referred to as MIDI CALLS®.

Misdirected calls include a category of telephone calls (i.e., incomplete) where for whatever reason, a properly dialed number is not connected with the intended recipient. Misdirected calls further include a category of telephone calls (i.e., disconnected) where a caller and a recipient lose the connection during the middle of the call. From the point of view of the service provider, every misdirected call is an opportunity to request the caller to participate in a survey.

It is estimated that phone carriers and ancillary voice traffic service providers have 5 to 10 Billion misdirected calls a month out of the 150 Billion calls that are transported in the US and Canada. The actual survey can be given on the IVR by the caller responding to questions on their phone, can be given online via a text link to an online survey or can be given live by forwarding the caller to a live interviewer.

When a telephone-based survey is conducted, one known method is to call people and ask them to participate in a survey. This is called outbound calling. This method has seen a rapid decline in effectiveness, both in terms of cost and time as well as quality of the data. Telephone regulations prohibit the use of an auto-dialer (robo-dialer) to call mobile phones. Today, according to the Pew Research Institute, approximately 58% of US households will only answer a call received on their mobile phone, even if they have a land line. This means that outbound calling done manually to a mobile phone has the best chance of connecting to a person, but it is very expensive and time consuming. Additionally, due to the almost universal use of caller ID, people often do not answer the phone if the caller ID is not recognized. The results, as seen in a case study with RTI International, also shows that outbound calling is significantly less representative of the population than a system that is able to include Inbound Calling Surveys, using the system and method described herein.

Since the late 90's, a large % of research has migrated from the phone to online. Online research has advantages because it is fast and cost effective. However, online research has a major drawback for certain types of research, such as large population studies. Additionally, many segments of America are under-represented in online research. Those segments can include groups that are not well integrated into the general population or culture, groups with lower incomes, etc. Online research also relies on panels. A panel is a group of people that have agreed to take surveys, usually for compensation. However, panels represent less than 1% of the country.

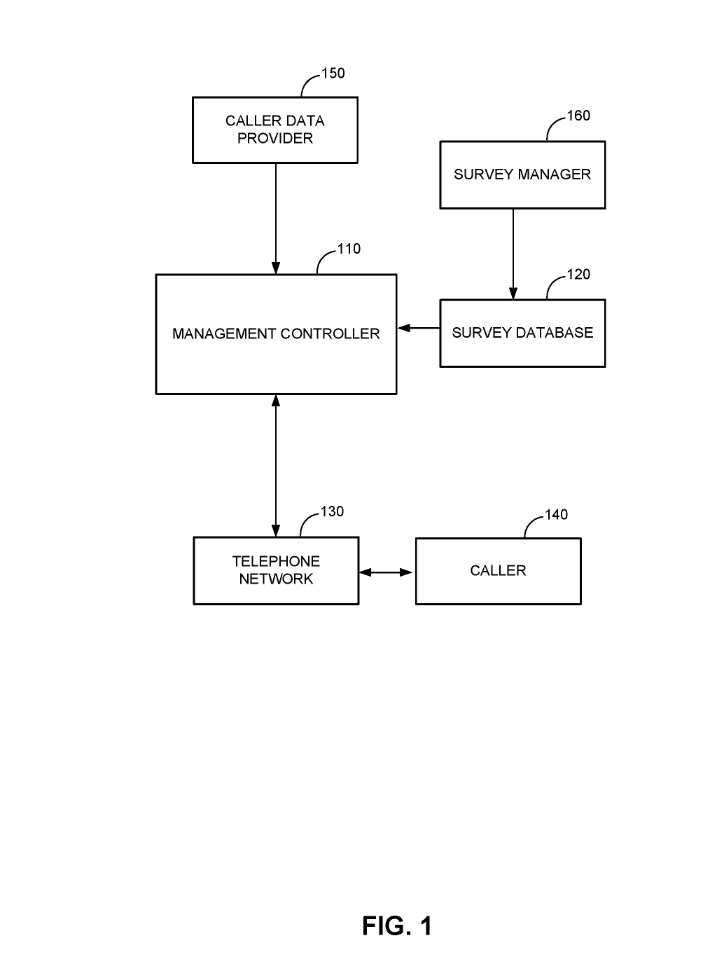

FIG. 1 illustrates a block diagram of an example system 100 for conducting telephone surveys. The system 100 includes a management controller 110, a survey database 120, a telephone network 130, a caller 140, a caller data provider 150, and a survey manager 160.

The management controller 110 receives a misdirected call by the caller 140 over the telephone network 130. The telephone network 130 is a telecommunications network used for telephone calls between two or more parties. For example, the telephone network 130 can include a landline network where the telephones must be directly wired into a single telephone exchange. This is known as the public switched telephone network (PSTN). The telephone network 130 can include a wireless network where the telephones are mobile and can move around anywhere within the coverage area. The telephone network 130 can also include a Voice Over Internet Protocol (VOIP) network where voice is digitized and communicated over the Internet, using an Internet Protocol (IP).

The management controller 110 can include one or more microcontrollers, server devices, or any other management system with data processing capabilities. The management controller 110 accesses surveys stored on a survey database 120. The survey database 120 can store political surveys, market analysis surveys, opinion surveys, interest surveys, or any other survey that may be conducted over the telephone.

The survey manager 160 provides the survey database 120 with available surveys. In some implementations, a surveying party (e.g., a customer) pays for a survey to be conducted by the management controller 110 and provides the survey to the survey manager 160.

The management controller 110 can extract certain caller data from the telephone number of the misdirected call itself. For example, the telephone number's area code can indicate the approximate geographical location of the caller. In addition, the caller data may include caller identification (CID) information in addition to the telephone number.

In some implementations, the management controller 110 receives additional caller data from the caller data provider 150. For example, the caller data provider 150 can include data collection companies or government entities that provide caller data as a service. The caller data provider 150 can provide caller data to the management controller 110 based on the caller's phone number. For example, the caller data provider can provide demographic information about the caller, such as age, sex, occupation, income bracket, etc.

In some implementations, the management controller 110 can obtain further caller data by directly asking the caller for the caller information via voice messages. The caller can then respond using a telephone keypad or spoken words. Different keypresses or combinations of keypresses on the telephone keypads can correspond to different answer choices. Spoken words can be interpreted by the management 110 controller using voice recognition software.

The management controller 110 selects a survey from the available surveys on the survey database, based on the caller data. For example, a survey regarding cigarette preferences might be selected if the management controller 110 determines that the caller is a cigarette smoker.

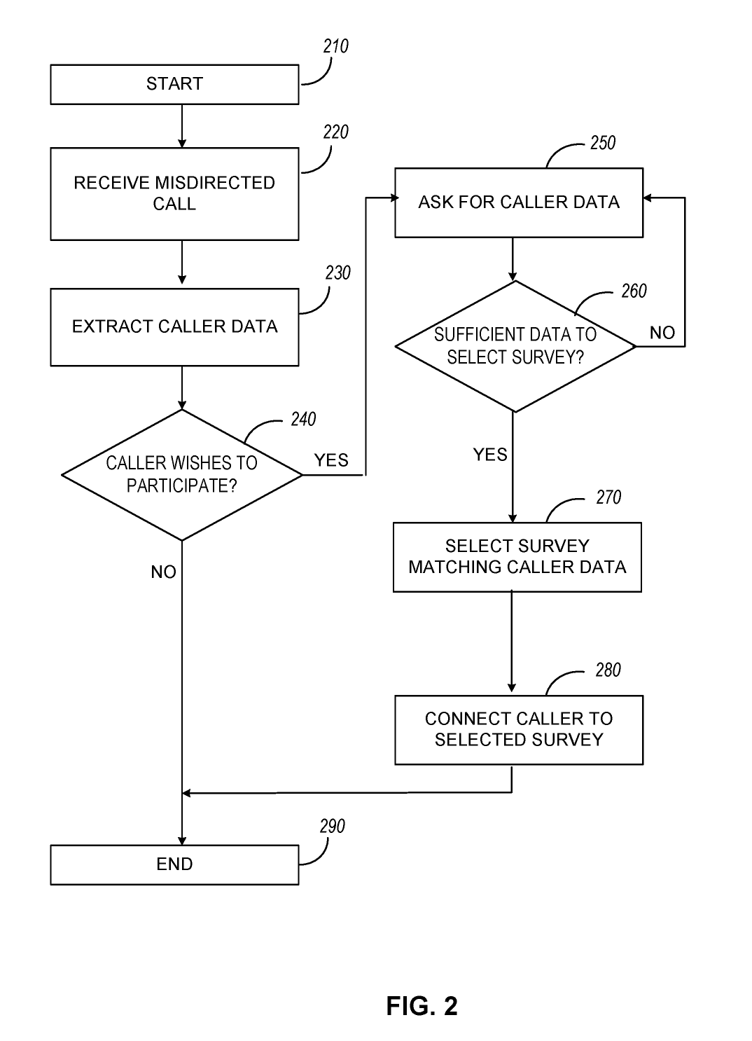

FIG. 2 illustrates a flow chart 200 of an example method for conducting telephone surveys. The method starts at step 210. At step 220, a management controller receives a misdirected call by a caller on a telephone network. In some implementations, the misdirected call is forwarded to the management controller by a misdirected call provider or company, such as a Local Exchange Carrier (LEC). In some implementations, the misdirected call is one of a misdialed number call, an incomplete call, or a disconnected number call.

At step 230, the management controller extracts caller data for the caller from the misdirected call. In some implementations, the management controller can extract the approximate geographical location of the caller based on the caller number's area code. In some implementations, the management controller uses reverse phone lookup on the caller number. In some implementations, the management controller can obtain the caller data from a caller data provider or company that provides caller data as a service. For example, the caller data provider can provide demographic information about the caller, such as age, sex, occupation, income bracket, etc. In some implementations, the management controller extracts CID information along with the caller number. In other instances this data is self reported by the caller in response to questions the IVR asks about gender, race, etc.

At step 240, the management controller determines whether the caller wishes to participate in a telephone survey. For example, the management controller can ask the caller using a prerecorded or software generated voice message. In some implementations, the management controller informs the caller of a reward if the caller is to finish the survey. The caller can respond agreement or rejection of the survey using a keypad or spoken words (i.e., voice entry). It is noted that in some implementations, step 240 can occur before, after, or simultaneously as step 230.

If the caller does not wish to participate, the method 200 ends at step 290. If the caller does wish to participate, at step 250, the management controller determines how the survey will be administered, and asks the caller for caller data. The caller data may be used to qualify or disqualify the caller for particular surveys. In some implementations, the management controller plays a voice message to the caller asking a question about the caller's status (i.e., age, sex, income bracket, marital status, hobbies, geographical area, occupation, etc.). In some implementations, the caller data includes at least one screen parameter (i.e., reduces number of surveys that are applicable to the caller). The survey can be administered using IVR with keypad and/or spoken words for responses. The survey can also be administered by directing the caller to a web page, where they use typical computer interaction to complete the survey. For example, if the caller is using a mobile telephone, they might be sent a text message that includes a link or URL that takes the caller to a web page to complete the survey. Or, the caller can be given the link or URL by voice, and they can open a web browser and then enter the link or URL, which takes them to a web page to complete the survey.

At step 260, the management controller determines if there is sufficient caller data to select a specific survey from a list of available surveys on a survey database. For example, there is a first survey intended for participants that are smokers between ages 20 and 29. If the management controller asks the caller a first question for the caller's age, there is still insufficient caller data to select the first survey. If there is insufficient caller data to select a specific survey, the management controller, at step 250, asks the caller another question to obtain more caller data. For example, the management controller can ask a second question for whether the caller is a smoker. If the caller answers yes to smoking, then the management controller may have sufficient caller data to select the first survey.

If the management controller has sufficient caller data to select a specific survey, at step 270, the management controller selects the specific survey based on the caller data. At step 280, the management controller connects the caller to the selected survey. Although not illustrated, the management controller may restart the process at step 250 to reselect a survey for example if the caller does not qualify for a particular survey.

In some implementations, the management controller provides reward information to the caller for collecting the reward, in response to the caller completing the survey. In some implementations, the reward corresponds to the survey that the caller completes. Rewards can for example include gift cards, vouchers, coupons, free goods/services, currency, etc. For example, more time consuming surveys can correspond to higher rewards. In some implementations, the management controller communicates to the caller an internet address and a reward code for collecting the reward. For example, the management controller can speak and/or send via text message the internet address and reward code to the caller. The method 200 ends at step 290.

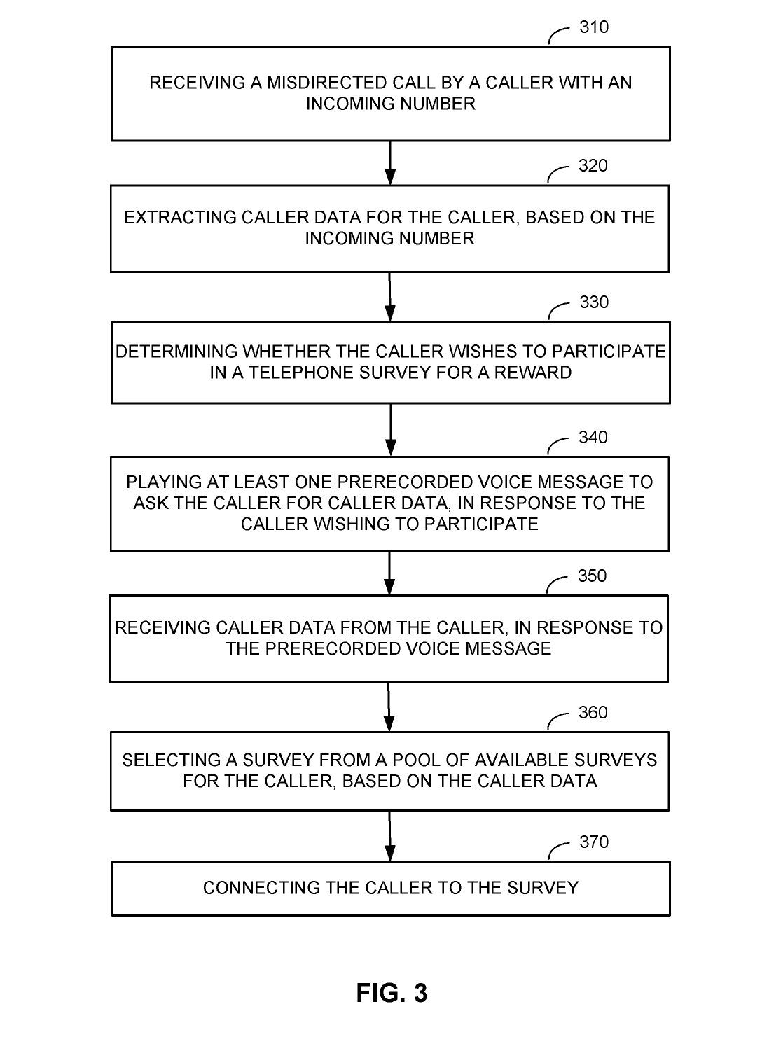

FIG. 3 illustrates a first example method 300 for conducting telephone surveys, by a management controller. At step 310, the management controller receives a misdirected call by a caller with an incoming number. In some implementations, the misdirected call is one of a misdialed number call, an incomplete call, or a disconnected number call. In some implementations, the misdirected call is redirected from a call center.

At step 320, the management controller extracts caller data for the caller, based on the incoming number. In some implementations, extracting the caller data includes using reverse phone lookup on the incoming number. In some implementations, extracting caller data includes determining a caller location for the incoming number.

At step 330, the management controller determines whether the caller wishes to participate in a telephone survey for a reward. In some implementations, the management controller plays at least one voice message to ask the caller for caller data, in response to the caller wishing to participate, and receives caller data from the caller, in response to the voice message.

At step 340, the management controller plays at least one voice message to ask the caller for caller data, in response to the caller wishing to participate.

At step 350, the management controller receives caller data from the caller, in response to the voice message. In some implementations, the caller data includes at least one screening parameter. In some implementations, receiving caller data from the caller includes at least one of receiving a keypad press or a voice entry.

At step 360, the management controller selects a survey from a pool of available surveys for the caller, based on the caller data.

At step 370, the management controller connects the caller to the survey.

In some implementations, the management controller provides reward information to the caller for collecting the reward, in response to the caller completing the survey, where the reward corresponds to the survey. In some implementations, the reward information includes an internet address and reward code.

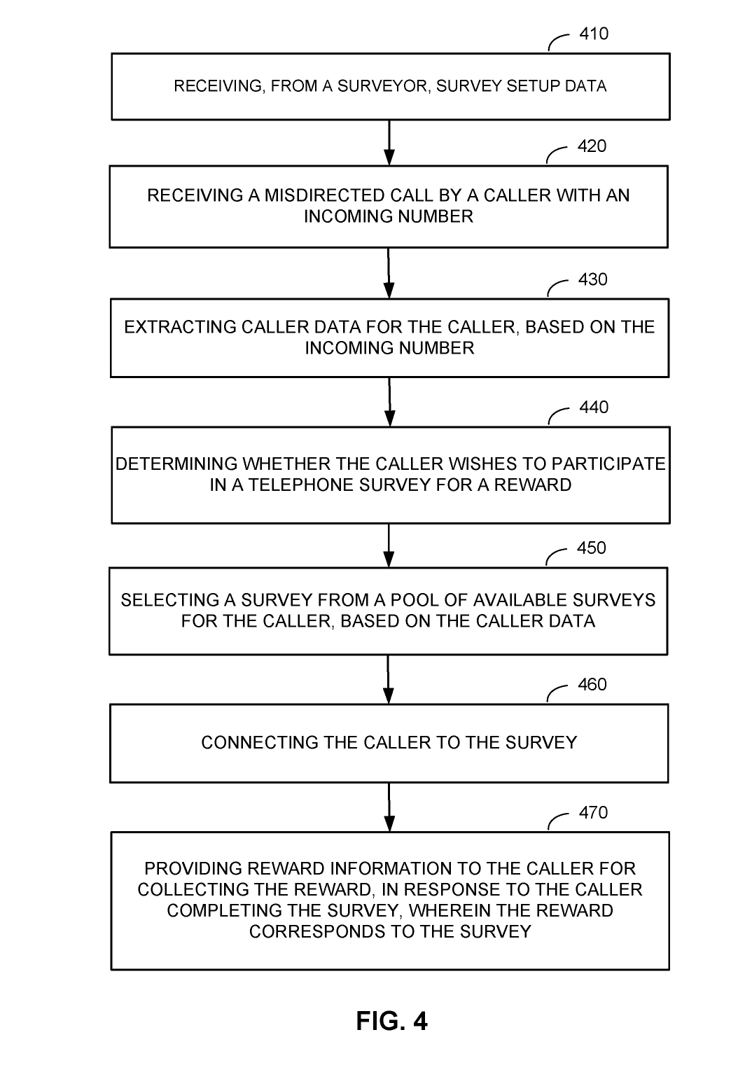

FIG. 4 illustrates a second example method 400 for conducting telephone surveys, by a management controller. At step 410, the management controller receives, from a surveyor, survey setup data.

In some implementations, the survey setup data includes: at least one question for a survey into a website form, at least one screening parameter for surveyees to pass, a desired number of completions for the survey, a time period to perform the survey, and an agreement for a fee to conduct the survey.

In some implementations, the management controller determines the fee based on at least one of the at least one screening parameters, the desired number of questions, and the time period. In some implementations, the management controller determines the reward based on the fee and the desired number of questions.

At step 420, the management controller receives a misdirected call by a caller with an incoming number.

At step 430, the management controller extracts caller data for the caller, based on the incoming number. In some implementations, extracting the caller data includes using reverse phone lookup on the incoming number.

At step 440, the management controller determines whether the caller wishes to participate in a telephone survey for a reward. In some implementations, the management controller plays at least one voice message to ask the caller for caller data, in response to the caller wishing to participate, and receives caller data from the caller, in response to the voice message.

At step 450, the management controller selects a survey from a pool of available surveys for the caller, based on the caller data.

At step 460, the management controller connects the caller to the survey.

At step 470, the management controller provides reward information to the caller for collecting the reward, in response to the caller completing the survey, where the reward corresponds to the survey.

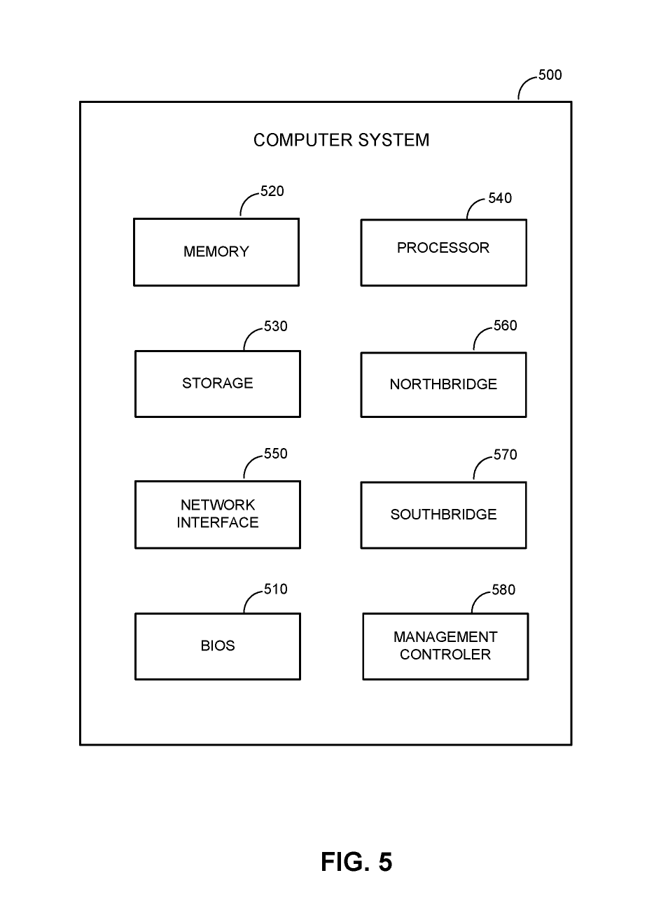

FIG. 5 illustrates a block diagram of an example computer system 500 for conducting telephone surveys. The computer system 500 includes a processor 540, a network interface 550, a management controller 580, a memory 520, a storage 530, a BIOS 510, a northbridge 560, and a southbridge 570. In some embodiments, computer system 500 is part of a distributed computer system or “cloud.”

The computer system 500 is, for example, a server (e.g., a server in a server rack of a data center) or a personal computer. The processor (e.g., central processing unit (CPU)) 540 is a chip on a motherboard that retrieves and executes programming instructions stored in the memory 520. The processor 540 is a single CPU with a single processing core, a single CPU with multiple processing cores, or multiple CPUs. One or more buses (not shown) transmit instructions and application data between various computer components such as the processor 540, memory 520, storage 530, and networking interface 550.

The memory 520 includes any physical device used to temporarily or permanently store data or programs, such as various forms of random-access memory (RAM). The storage 530 includes any physical device for non-volatile data storage such as a HDD or a flash drive. The storage 530 can have a greater capacity than the memory 520 and can be more economical per unit of storage, but can also have slower transfer rates.

The BIOS 510 includes a Basic Input/Output System or its successors or equivalents, such as an Extensible Firmware Interface (EFI) or Unified Extensible Firmware Interface (UEFI). The BIOS 510 includes a BIOS chip located on a motherboard of the computer system 500 storing a BIOS software program. The BIOS 510 stores firmware executed when the computer system is first powered on along with a set of configurations specified for the BIOS 510. The BIOS firmware and BIOS configurations are stored in a non-volatile memory (e.g., NVRAM) or a ROM such as flash memory. Flash memory is a non-volatile computer storage medium that can be electronically erased and reprogrammed.

The BIOS 510 is loaded and executed as a sequence program each time the computer system 500 is started. The BIOS 510 recognizes, initializes, and tests hardware present in a given computing system based on the set of configurations. The BIOS 510 performs self-test, such as a Power-on-Self-Test (POST), on the computer system 500. This self-test tests functionality of various hardware components such as hard disk drives, optical reading devices, cooling devices, memory modules, expansion cards and the like. The BIOS addresses and allocates an area in the memory 520 in to store an operating system. The BIOS 510 then gives control of the computer system to the OS.

The BIOS 510 of the computer system 500 includes a BIOS configuration that defines how the BIOS 510 controls various hardware components in the computer system 500. The BIOS configuration determines the order in which the various hardware components in the computer system 500 are started. The BIOS 510 provides an interface (e.g., BIOS setup utility) that allows a variety of different parameters to be set, which can be different from parameters in a BIOS default configuration. For example, a user (e.g., an administrator) can use the BIOS 510 to specify clock and bus speeds, specify what peripherals are attached to the computer system, specify monitoring of health (e.g., fan speeds and CPU temperature limits), and specify a variety of other parameters that affect overall performance and power usage of the computer system.

The management controller 580 is a specialized microcontroller embedded on the motherboard of the computer system. For example, the management controller 580 is a baseboard management controller (BMC). The management controller 580 manages the interface between system management software and platform hardware. Different types of sensors built into the computer system report to the management controller 580 on parameters such as temperature, cooling fan speeds, power status, operating system status, etc. The management controller 580 monitors the sensors and has the ability to send alerts to an administrator via the network interface 550 if any of the parameters do not stay within preset limits, indicating a potential failure of the system. The administrator can remotely communicate with the management controller 580 to take some corrective action such as resetting or power cycling the system to restore functionality.

Although not unique for the system and method, in one embodiment, computer system 500 includes a northbridge chip 560, and a southbridge chip 570. The northbridge 560 is a chip on the motherboard that can be directly connected to the processor 540 or is integrated into the processor 540. In some instances, the northbridge 560 and the southbridge 570 is combined into a single die. The northbridge 560 and the southbridge 570, manage communications between the processor 540 and other parts of the motherboard. The northbridge 560 manages tasks that require higher performance than the southbridge 570.

The northbridge 560 manages communications between the processor 540, the memory 520, and video controllers (not shown). In some instances, the northbridge 560 includes a video controller.

The southbridge 570 is a chip on the motherboard connected to the northbridge 560, but unlike the northbridge 560, need not be directly connected to the processor 540. The southbridge 570 manages input/output functions, such as Universal Serial Bus (USB), audio, serial, BIOS, Serial Advanced Technology Attachment (SATA), Peripheral Component Interconnect (PCI) bus, PCI eXtended (PCI-X) bus, PCI Express bus, ISA bus, SPI bus, eSPI bus, SMBus, of the computer system 500. The southbridge 570 connects to or includes within the southbridge 570 the management controller 570, Direct Memory Access (DMAs) controllers, Programmable Interrupt Controllers (PICs), and a real-time clock. In some instances, the southbridge 570 directly connects to the processor 540, such as in the case where the northbridge 560 is integrated into the processor 540. In some sytems, the northbridge 560 and the southbridge 570 can be combined into a single die, such as for example into a platform controller hub (PCH).

The networking interface 550 is any interface that supports wired or wireless Local Area Networks (LANs) or Wide Area Networks (WANs), such as Ethernet, Fibre Channel, Wi-Fi, Bluetooth, Firewire, the Internet, etc. For example, the networking interface 550 can include a network interface controller (NIC) for Ethernet. Ethernet has been the most widely used networking standard for connecting computers in both Local Area Networks (LANs) and Wide Area Networks (WANs). Ethernet defines a number of wiring and signaling standards for the physical layer (PHY), through means of network access at the Media Access Control (MAC)/Data Link Layer, and through a common addressing format. Ethernet enabled devices typically communicate by transmitting data packets, which comprise blocks of data that are individually sent and delivered.

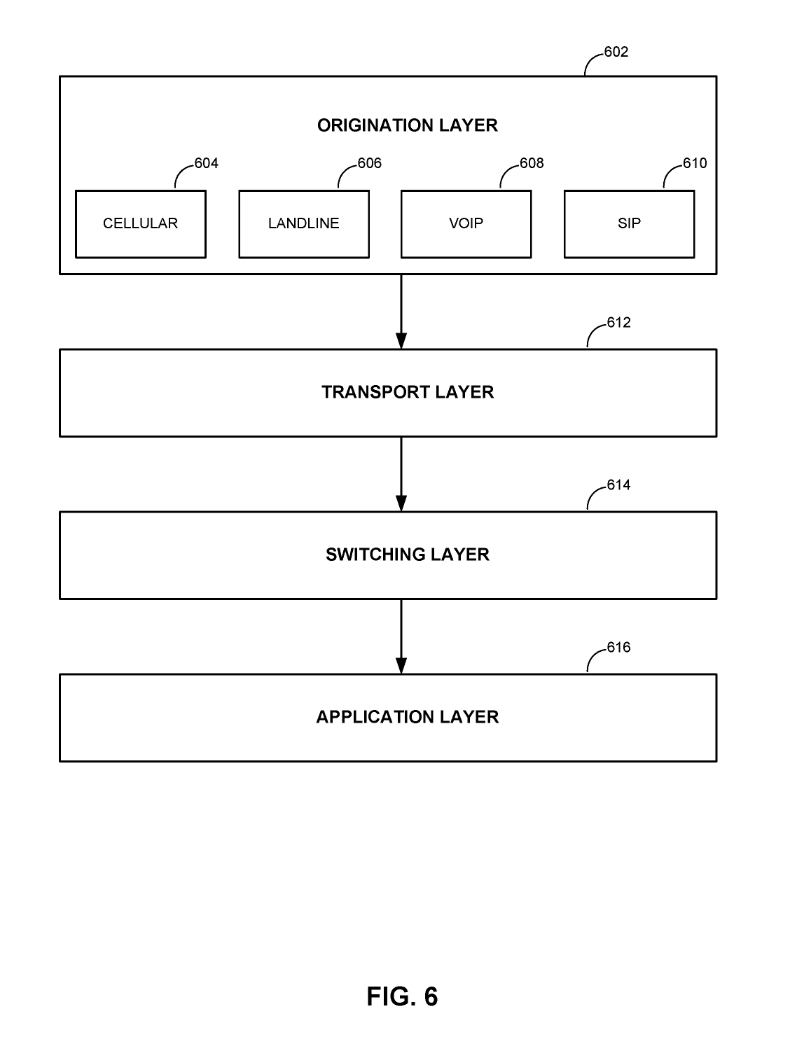

FIG. 6 illustrates a block diagram of an example system 600 for conducting telephone surveys. The system 600 includes a number of layers or functions. In one embodiment, system 600 includes an origination layer 602. Inbound calls originate from entities in the origination layer 602, and can include cellular telephone networks 604, landline networks sometimes call the Public Switched Telephone Network (PSTN) 606, Voice over Internet Protocol (VOIP) networks 608 and Session Initiating Protocol (SIP) networks 610. The entities in origination layer 602 provide telephone services to callers, or have connections to telephone services used by callers.

In one embodiment, transport layer 612 provides a connection between the origination layer 602 and a switching layer 614. Within the switching layer 614, IVR functions are provided, as well as many of the other features described. In one embodiment, computer system 500 is a component of or the features of computer system 500 are performed by a component in the switching layer 614.

The application layer 616 connects to the switching layer 614, and provides an interface for survey administrators, and system administrators to manage and interface with the system 600. Application layer 616 is generally a graphical user interface (GUI) that may be a stand-alone application, or it may provide access using a web browser.

The various illustrative logical blocks, modules, and circuits described in connection with the disclosure herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor is a microprocessor, or in the alternative, any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor reads information from, and write information to, the storage medium. In the alternative, the storage medium is integral to the processor. The processor and the storage medium resides in an ASIC. The ASIC resides in a user terminal. In the alternative, the processor and the storage medium resides as discrete components in a user terminal.

In one or more exemplary designs, the functions described is implemented in hardware, software, firmware, or any combination thereof. If implemented in software, the functions are stored on or transmitted over as one or more instructions or code on a non-transitory computer-readable medium. Non-transitory computer-readable media includes both computer storage media and communication media including any medium that facilitates transfer of a computer program from one place to another. A storage media is any available media that can be accessed by a general purpose or special purpose computer. By way of example, and not limitation, such computer-readable media includes RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein can be applied to other variations without departing from the scope of the disclosure. Thus, the disclosure is not intended to be limited to the examples and designs described herein, but is to be accorded the widest scope consistent with the principles and novel features disclosed herein.

1. A method, by a management controller, for conducting telephone surveys, comprising:
receiving a misdirected call by a caller;
extracting caller data for the caller, based at least on the incoming number;
determining that the caller wishes to participate in a telephone survey;
soliciting the caller for caller data using at least a voice message, in response to determining that the caller wishes to participate;
receiving the caller data from the caller;
selecting a survey from a plurality of surveys for the caller, based at least on the caller data; and
connecting the caller to the survey.

2. The method of claim 1, further comprising providing reward information to the caller for collecting a reward, in response to the caller completing the survey, wherein the reward corresponds to the survey.

3. The method of claim 2, wherein the reward information comprises an internet address and reward code.

4. The method of claim 1, wherein the caller data comprises at least one screening parameter.

5. The method of claim 1, wherein the misdirected call is one of a misdialed number call, an incomplete call, or a disconnected number call.

6. The method of claim 1, wherein the misdirected call is redirected from at least one of a local exchange carrier, an interexchange carrier, or a voice traffic service provider. The method of claim 1, further comprising:
determining an incoming number of the misdirected call; and
determining a caller location for the incoming number.

8. The method of claim 1, further comprising:
determining an incoming number of the misdirected call; and
determining additional caller data using reverse phone lookup on the incoming number.

9. The method of claim 1, wherein receiving caller data from the caller comprises at least one of receiving a keypad press or a voice entry.

10. A method, by a management controller, for conducting telephone surveys, comprising:
receiving, from a surveyor, survey setup data;
receiving a misdirected call by a caller;
determining caller data for the caller;
determining that the caller wishes to participate in a telephone survey;
selecting a survey from a plurality of surveys for the caller, based at least on the caller data;
connecting the caller to the survey; and
providing reward information to the caller for collecting the reward, in response to the caller completing the survey, wherein the reward corresponds to the survey.

11. The method of claim 10, further comprising:
playing at least one voice message to ask the caller for the caller data, in response to determining that the caller wishes to participate; and
receiving the caller data from the caller.

12. The method of claim 10, wherein the survey setup data comprises:
at least one question for a survey into a website form,
at least one screening parameter for surveyees to pass,
a desired number of completions for the survey,
a time period to perform the survey, and
an agreement for a fee to conduct the survey.

13. The method of claim 12, further comprising determining the fee based on at least one of the at least one screening parameters, the desired number of questions, and the time period.

14. The method of claim 12, further comprising determining the reward based on the fee and the desired number of questions.

15. A system, by a management controller, for conducting telephone surveys, comprising:
a storage configured to:
store a plurality of available surveys; and
store information corresponding to at least one voice message; and
a processor connected to a telephone network and configured to:
receive a misdirected call by a caller;
determine that the caller wishes to participate in a telephone survey;
play the at least one voice message to ask the caller for caller data, in response to determining that the caller wishes to participate;
receive the caller data from the caller, in response to the voice message;
select a survey from the plurality of available surveys for the caller, based at least on the caller data; and
connect the caller to the survey.

16. The system of claim 15, wherein the processor is further configured to provide reward information to the caller for collecting a reward, in response to the caller completing the survey, wherein the reward corresponds to the survey.

17. The system of claim 15, wherein the caller data comprises at least one screening parameter.

18. The system of claim 15, wherein the misdirected call is one of a misdialed number call, an incomplete call, or a disconnected number call.

19. The system of claim 15, wherein the misdirected call is redirected from at least one of a local exchange carrier, an interexchange carrier, or a voice traffic service provider.

20. The system of claim 15, wherein the processor is further configured to:
determine an incoming number of the misdirected call; and
determine a caller location for the incoming number.
